(19) United States
(12) Patent Application Publication
(10) Pub. No.: US 2023/0080121 A1
(43) Pub. Date: Mar. 16, 2023

(54) Direct Soling

(71) Applicant: adidas AG, Herzogenaurach (DE)

(72) Inventors: Marco Fischhold, Neustadt an der Aisch (DE); Eric Jeandin, Nuremberg (DE); Sergius Merker, Neustadt an der Aisch (DE); Harald Geyer, Lonnerstadt (DE); Felix Voelker, Stegaurach (DE); Fabian Pilske, Scheinfeld (DE)

(21) Appl. No.: 17/943,406

(22) Filed: Sep. 13, 2022

(30) Foreign Application Priority Data
Sep. 13, 2021 (DE) 102021210100.3

(51) Int. Cl. B29D 35/06; A43D 3/00

(52) U.S. Cl. CPC B29D 35/061; A43D 3/00; B29K 2105/04

(57) ABSTRACT

A method for manufacturing a shoe can include a) lasting an upper; b) providing an open sole casting mold; c) foaming sole material outside the sole casting mold; d) injecting the foamed sole material into the sole casting mold; and e) bringing the lasted upper into contact with the injected sole material.

### CROSS REFERENCE TO RELATED APPLICATION

This application is related to and claims priority benefits from German Patent Application No. DE 10 2021 210 100.3, filed on Sep. 13, 2021, entitled METHOD AND APPARATUS FOR DIRECT SOLING (“the '100 application”). The '100 application is hereby incorporated herein in its entirety by this reference.

### TECHNICAL FIELD

The present disclosure relates to a method for direct soling of shoes, for example of sports shoes, and more particularly, but not necessarily exclusively, to foaming sole material outside a sole casting mold, injecting the foamed sole material into the sole casting mold, and bringing an upper into contact with the injected sole material. The present disclosure further relates to an apparatus for direct soling of shoes.

### BACKGROUND

A plurality of methods for manufacturing shoes are known from the prior art. Usually, a lasted upper and a sole are provided separately and then brought into connection by different methods, for example by a suitable adhesive. In alternative methods and apparatuses, the sole and the upper are connected by a prior surface processing of the sole, for example by heat treatment, melting, infrared welding, or the like. Due to the complex and cost-intensive work steps and equipment associated with these methods and apparatuses, there is desirability of an improved method and an improved apparatus for manufacturing a shoe, which comprises the connection of the sole to the lasted upper.

In the direct soling method (Direct Soling), a cavity of a molding tool is filled with a molding compound, from which a shoe sole may be molded. While the molding compound still has an increased temperature, a lasted upper is brought into connection with the injected molding compound. In this way, a connection between the lasted upper and the sole can occur.

In the prior art, some attempts have been made to implement the direct soling method, which, however, have some disadvantages, as will be shown in the following:

For example, the documents CN 110744758 A, CN 212826416 U, EP 1468815 A1 or also US 2014/068879 A1 relate to the pouring method. In the pouring or casting method, a molding compound is poured through a tilting nozzle into an open mold by use of a backward movement of the nozzle. Subsequently, the last is moved towards the molding compound with the shoe shaft from top to bottom, while a bottom stamp moves the filled mold upwards. The disadvantage here is the associated long duration until the molding compound is injected into the mold. A further disadvantage is the large drop in temperature during the pouring of the molding compound, thereby increasing the viscosity of the material and making the step of connecting to the lasted upper more difficult. The favorable time window possible for this is also restricted. It would have to be poured at an increased temperature in order to compensate for the drop in temperature, so that an increased effort and increased costs are associated, whereby the method becomes inefficient.

Document EP 3623133 A1 relates to the further possibility of manufacturing a sole or a shoe, in which the molding compound is injected into the mold under increased pressure. The molding compound may be foamed with CO2, for example. Thus, a high effort is associated, since the tightness of the mold must be ensured by suitable apparatus measures. For example, in this method, the wall thicknesses of the molded body or the casting mold must be increased in order to withstand the increased internal pressure. In addition, particularly resistant materials must be used. In addition, suitable seals must be provided at the complex geometries, which withstand the frequently performed method cycles. This requires a high cost and maintenance effort and also an increased risk of production failure for the operator.

Document US 2019/0365027 A1 relates to an upper which is directly connected to the sole. The directly attached sole has an insert, such as an airbag, which forms a part of a sidewall. The insert is visible from the outside and forms at least a part of the outer sidewall of the sole. The insert is molded into the directly attached sole by bringing the insert or a mask temporarily connected to the insert into contact with a sidewall mold surface of a mold used in the direct attaching process, so that the insert forms a visible element of the directly attached sole.

Starting from this prior art, an objective may be to provide a method for direct soling, whereby the above-mentioned disadvantages of the prior art may be overcome. In particular, an object may be to provide a method which facilitates the manufacture of shoes by an improved, faster, more efficient, and cost-reduced direct soling.

A further objective may be to provide an apparatus for direct soling in order to overcome the above-mentioned disadvantages of the prior art. In particular, a simplified apparatus may be provided, with which a plurality of cycles for manufacturing shoes may be enabled in a short time. The provided apparatus may be more cost-effective than previous apparatuses and thus be used very economically. In addition, it may involve a very low maintenance effort, can avoid high demands on the tightness, and may be built with constructively easy mechanisms and may thus be easy and automated to control and to be controlled in an automated manner.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments, a method for manufacturing a shoe is provided. The method can include a) lasting an upper; b) providing an open sole casting mold, c) foaming sole material outside the sole casting mold, d) injecting the foamed sole material into the sole casting mold, and e) bringing the lasted upper into contact with the injected sole material.

In some embodiments, the sole material experiences a density change of at most 5% relative to the density of the sole material during the injecting in a time of 0.5 seconds after injecting into the sole casting mold.

In some embodiments, the foaming of the sole material may include: c.1) providing a first material, the first material may include at least one selected from thermoplastics, elastomers, or thermosets; and c.2) providing at least one blowing agent.

In some embodiments, providing of the first material occurs in the form of pellets, and providing of the at least one blowing agent occurs in the form of pellets.

In some embodiments, the foaming of the sole material further may include: c.3) forming a mixture of the first material and the blowing agent; and c.4) drying the mixture, where drying is arranged such that the maximum moisture content of the mixture is 2.0% or less.

In some embodiments, the foaming of the sole material further may include: c.5) compacting and heating the mixture to cause an interaction that includes a foaming of the mixture, where the foaming is accompanied by a decrease in density.

In some embodiments, the density of the injected sole material is in a range between 0.2-1.2 g/cm

In some embodiments, the direction in which the sole material is injected into the sole casting mold changes relative to the sole casting mold over time.

In some embodiments, the method steps may include an air entry and/or air exit between the sole casting mold and the environment.

In some embodiments, the method steps may include an absolute value of pressure difference between the sole casting mold and the environment of a maximum of 10% of the environmental pressure.

In some embodiments, the method further may include changing a geometry of the sole casting mold to bring the injected sole material into a predefined shape.

In some embodiments, the method may include moving the lasted upper towards the sole casting mold.

In some embodiments, the method may include molding a lower surface of the lasted upper such that the lower surface substantially forms an upper closing surface of the sole casting mold.

In some embodiments, molding of the lower surface is performed prior to injecting the sole material, where the surface continues to exist in further method steps.

In some embodiments, the injected sole material is configured to form a sole.

In some embodiments, the sole is attached to the lasted upper, where the attachment occurs without additional adhesive.

In some embodiments, the lasted upper may include the same material as the injected sole material.

According to certain embodiments, a shoe is manufactured according to a method.

According to certain embodiments, an apparatus for manufacturing a shoe is provided. The apparatus may include a) at least one open sole casting mold configured to receive a lasted upper; b) at least one sprayer configured to be placed in communication with the sole casting mold to enable injection of sole material into the sole casting mold, and c) at least one foaming unit configured to foam the sole material prior to injection into the sole casting mold.

In some embodiments, the sole casting mold with the received upper is substantially not sealed airtight.

In some embodiments, an air entry and/or air exit between the sole casting mold with the received upper and the environment is enabled.

In some embodiments, an absolute value of pressure difference between the sole casting mold with the received upper and the environment of a maximum of 10% of the environmental pressure is included.

In some embodiments, the sole material and/or the sprayer are configured such that the direction in which the sole material is injected into the sole casting mold changes relative to the sole casting mold over the time.

In some embodiments, the injected sole material is configured to experience substantially no further expansion.

In some embodiments, the sole material is configured to include a density change of a maximum of 5% relative to the density of the sole material during the injecting in a time of 0.5 seconds after injecting into the sole casting mold.

In some embodiments, the foaming unit may include at least: a) a mixer configured to mix (i) a first material that may include at least one selected from thermoplastics, elastomers, or thermosets, and (ii) at least one blowing agent into a mixture; b) a dryer configured to dry the mixture or the first material; and c) a compactor and heater configured to compact the mixture and to supply heat to the mixture to cause a foaming of the mixture.

In some embodiments, the dryer may include a heating unit and a fan unit configured to provide a maximum moisture content of the mixture of 2.0%.

In some embodiments, the compactor and the heater may include at least one extruder and at least one heating system, where the extruder may include at least one screw arranged such that rotational movement of the screw causes the mixture to be blended, compacted and transported.

In some embodiments, the sole casting mold further may include a traverse element configured to change the geometry of the sole casting mold and to bring the injected sole material into a predefined shape, where a movement of the traverse element in one direction decreases the volume of the sole casting mold, and where a movement of the traverse element in the opposite direction increases the volume of the sole casting mold.

In some embodiments, the traverse element is movable in a first translational direction, where the first translational direction is substantially perpendicular to a lower surface of the lasted upper.

In some embodiments, the sole casting mold and/or the traverse element may include plastic material.

In some embodiments, the sole casting mold may include at least two opposing elements configured to receive and release the upper, where the at least two opposing elements are movable in a second translational direction, and where receiving and releasing of the upper occurs by an opposing translational movement of the at least two elements.

In some embodiments, the first translational direction and the second translational direction are oriented substantially perpendicular to each other.

In some embodiments, the sole material is injected into the sole casting mold by a channel that may be included by walls of the sole casting mold, where a size of an opening of the channel is adjustable, and where the diameter of the opening is in the range of 2-30 mm.

In some embodiments, the size of the opening of the channel is in the range of 2-16 mm or where the diameter of the channel substantially corresponds to the diameter of the sprayer.

In some embodiments, the apparatus further includes a plurality of sole-casting molds, where the sole casting molds are arranged movable to the at least one sprayer.

In some embodiments, the sole casting molds are arranged circularly, and are configured such that a relative movement to the at least one sprayer is performed by rotation about the central axis of the circular arrangement.

### BRIEF DESCRIPTION OF THE DRAWINGS

In the following detailed description, embodiments of the invention are described referring to the following figures:

FIG. 1 is a flow chart illustrating a process according to various embodiments;

FIG. 2 is a flow diagram illustrating some examples of operations and apparatus features that may be utilized according to various embodiments;

FIG. 3 is a diagram illustrating preparation of sole material outside a sole casting mold in a foaming unit according to various embodiments;

FIG. 4 is a diagram illustrating a plurality of sole casting molds with a sprayer and a foaming unit according to various embodiments;

FIG. 5 is a diagram illustrating an apparatus for manufacturing a shoe with cooling channels according to various embodiments;

FIGS. 6a, 6b, 6c, and 6d are diagrams illustrating manufacturing a shoe during an injection process according to various embodiments.

### BRIEF DESCRIPTION

The above-described objectives and objects, which are also mentioned when reading the following description or may be recognized by the person skilled in the art, may be achieved with a method, an apparatus, and/or a shoe as described herein. Beneficial further developments are also described. The technical characteristics shown in the following for the method, the benefits of the method, and the improvements over the prior art apply equally to the apparatus for carrying out the method.

In particular, the objectives may be achieved by a method for manufacturing a shoe, comprising the steps of: a) lasting an upper; b) providing an open sole casting mold; c) foaming sole material outside the sole casting mold; d) injecting the foamed sole material into the sole casting mold; and e) bringing the lasted upper into contact with the injected sole material.

This arrangement may provide a plurality of improvements, whereby in particular the disadvantages of the prior art may be overcome. The provision of an open sole casting mold may enable an easy closing of this mold by further components, as explained in more detail below. Thereby, “closing” or “closure” is not necessarily to be understood as an airtight closure. The foaming of sole material already outside the sole casting mold is particularly beneficial, since further foaming may be largely prevented after the injection. In particular, further expansion of the material in the sole casting mold can thus be substantially prevented. This enables the targeted provision of a final product, such as e.g. an entire shoe or a part of a shoe, for example a sole. In particular, the density of the final product may be determined and predicted very well in a beneficial manner by this type of material provision. The determination of the suitable contact pressures of further elements, for example a traverse element, punch or bottom punch, which acts on the sole material from below in order to bring it into the mold of the final product, can thus be simplified, since an independent expansion of the material in the sole casting mold is largely not present. In addition, a weight saving compared to other, disadvantageous methods of the prior art, e.g. the high-pressure injection method, may be enabled. Due to the contact of the lasted upper with the injected sole material, particularly the entire method may be improved, e.g., enabling the connection of both elements without additional auxiliary mechanisms, for example an adhesive or the like. Various embodiments of the method may be represented by the sequence of steps a), b), c), according to which first a closing of the upwardly opened sole casting mold occurs by the lasted upper. Thereafter, step d) occurs. Thereafter, a further step may follow, in which pressure is exerted from below onto the injected sole material, for example by a punch, bottom punch or the like. The punch may namely deform the sole casting mold such that the injected sole material located therein comes into contact with the upper. However, alternatively, step c) may also occur immediately before step d). In particular, the method may also comprise steps of curing, cooling, as well as moving an injection device towards and away from the sole casting mold. The pressure with which the material is injected into the sole casting mold may be in the range of 15 bar+/−6 bar. Depending on the type of material composition as well as the desired final product, other pressures may also be utilized.

The sole material used in the method may further experience a density change of at most of 5% relative to the density of the sole material during the injecting in a time of 0.5 seconds after injecting into the sole casting mold. Thereby, during the injecting, it is to be understood as the time in which the sole material gets into the sole casting mold.

Thus, among other things, the benefit may be achieved that the material already foamed outside the sole casting mold does not expand substantially further immediately after getting into the sole casting mold. In some embodiments, the time may also be 0.3 seconds, or 0.1 seconds. The maximum density change may in some embodiments be a maximum of 3% or a maximum of 1%. Thus, it may be beneficially ensured that the spatial expansion of the sole material foamed outside the sole casting mold is already largely determined. By a reduced expansion of the foamed sole material within the sole casting mold, a foaming over of edges of the sole casting mold may also be reduced. In addition, in this way, determination of suitable travel paths of a lasted upper and a movable component of the sole casting mold in order to bring the sole material into contact with the upper may be adjusted in advance and thus maintained for the entire shoe production and may be not subject to interfering influences or possibly fluctuations due to material contaminations, which would lead to a different expansion behavior. Before the injection, the sole material may be guided through walls, which are no longer present immediately after the injection into the sole casting mold and thus no longer delimit the sole material, for example. Between these two states, an expansion of the material may therefore still occur.

The foaming of the sole material comprised by the method may further comprise: c.1) providing of a first material, the first material comprising at least one of the list of thermoplastics, elastomers, and thermosets; and c.2) providing of at least one blowing agent. In some embodiments, the first material comprises thermoplastic polyurethane (TPU).

The first material used herein offers the benefit of a simple handling, a simple availability, and a facilitated processing. The blowing agent may in some embodiments comprise solid blowing agents and/or gaseous blowing agents, wherein solid blowing agents comprise chemical and/or physical solid blowing agents or a combination thereof, wherein gaseous blowing agents comprise, e.g., a CO2 gas injection. By using a type of TPU pellets with a blowing agent, the desired properties such as density and heat resistance and viscosity may be meaningfully adjusted and appropriately adjusted for the respective application, whereby the method may be improved. The method is not limited to the use of TPU as the first material. In particular, extrusion-capable materials could also be used.

Providing of the first material comprised by the method may further occur in the form of pellets. Providing of the at least one blowing agent may likewise occur in the form of pellets. In some embodiments, TPU pellets may also be used as the first material. In addition, these are in some embodiments mixed with blowing agents, wherein the blowing agents are likewise present in the form of pellets. Thus, beneficially, handling of the materials as well as processing of the materials and the apparatuses utilized therefore may be simplified and improved.

The foaming of the sole material comprised by the method may further comprise: c.3) forming a mixture of the first material and the blowing agent; and c.4) drying the mixture, wherein drying may be configured such that the maximum moisture content of the mixture is 2.0%. In some embodiments, the maximum moisture content of the mixture may also be 1.5%, or 1%, or 0.4%, or below 0.4%.

Due to the low moisture content of the mixture thus created, the risk of the formation of streaks or other undesired side effects in the final product may be avoided. A moisture content that is too high may also be undesired for the homogeneity of the final product, since the moisture spots have different damping properties than the remaining material. In addition, cavities may be formed in the final product. The wearing comfort may be accordingly increased by the provision of a low moisture content. Economic benefit may be provided by an efficient drying of the mixture, whereby the costs during production may be reduced. Further, drying may contribute to improving the processability of the mixture. In some cases, drying may contribute to also allowing processability in the first place. The mixture is in some embodiments configured such that a homogeneous distribution is formed, in which the components of the materials are uniformly distributed.

The foaming of the sole material comprised by the method may further comprise: c.5) compacting and heating the mixture to cause an interaction, in particular a foaming, of the mixture, wherein the foaming may be accompanied by a decrease in density.

By compacting and heating, the reaction of the mixture may be triggered and may also be controlled and/or influenced in a beneficial manner by the process parameters. By the reaction, the blowing agent may be activated and thereby the TPU material may foam. In this case, it may be particularly beneficial that the material is foamed prior to injection and may substantially already be present in a foamed state. Thus, after injection, foaming no longer takes place in some embodiments, and the material supply may be controlled better and in a beneficial manner for the respective product.

The density of the injected sole material used in the method may be in a range between 0.2-1.2 g/cm³. In some embodiments, the density may be in the range between 0.4-1.0 g/cm³ or between 0.45-0.8 g/cm³ or between 0.5-0.7 g/cm³. Some embodiments can include a possibly slight change of the density of the material in the moment of injection and the density of the material of the final product. In this case, the final product may be even more compacted, possibly due to geometry changes of the sole mold, as explained further below. Due to the different densities of the material supported by the method, beneficially light soles may also be provided, thus a wearing comfort may be considerably increased and improved. For example, lifting of the shoe or the foot may be facilitated when wearing the shoe. In particular, this may be accompanied by a saving of muscle strength. Due to lower densities, material may also be saved, whereby the manufacturing may occur in more economically and environmentally friendly manner. Higher densities may also be comprised and beneficially enable the provision of a stable shoe.

The present method may further be characterized in that the direction in which the sole material is injected into the sole casting mold changes relative to the sole casting mold over time.

The injection trajectory of the sole material may, for example, be curved, wavy and/or serpentine. Thereby, in some embodiments, the sole material changes its direction during the injection process. In particular, in some embodiments, the sole material does not inject necessarily and not during the entire course perpendicularly out of the outlet nozzle surface. Beneficially, it may be ensured by the material composition, among other things, that the material, even if it exits the nozzle outlet surface at high speed, hits against walls of the sole casting mold. In some embodiments, it nevertheless does not trigger any, possibly undesired, back-injections, whereby material could be widely scattered back and possibly escape the sole casting mold. The shape of the injection of the sole material may in particular be provided by a special shape of the sprue channel for profile specification of the foamed (or also extruded) TPU material. A square cross-section could possibly cause a different change of direction due to the foaming. A circular cross-section appears beneficial. The viscosity may also influence the formation of a curved, wavy, and/or serpentine formation of the sole material during injection. If the material is formed to be viscous, for example, the geometry of the sole material specified by the sprue channel beneficially does not flow in the sole casting mold in some embodiments. Instead, the material may better conform to the cavity specified by the sole casting mold and provide a homogeneous final material quality by folding and superimposing.

In particular, the curved, wavy, and/or serpentine formation of the sole material may form due to the cohesion of the sole material caused by the viscosity, whereby the sole material may maintain the shape even during the rebound, e.g., for example, after impinging on the sole casting mold or on an inner wall of the sole casting mold, and may beneficially overlap with the material flowing thereafter in the sole casting mold. Thus, a continuous thread consisting of the sole material having a thickness of approximately the cross-section of the sprue channel may be provided without back-injection, wherein the thread may form in the course of the injection always further into a folded or curved and wavy overlapping mass. The thickness of the thread may still change slightly over time. For example, the thickness of the thread may become somewhat larger over time. The thickness of the thread may thus also be larger than the cross-section of the sprue channel.

The method steps comprised by the present method may further comprise an air entry and/or air exit between the sole casting mold and the environment.

The air entry and/or air exit enabled with the method offers the benefit that no chamber, pressure chamber, no pressure-proof container, no autoclave, or something comparable has to be provided, whereby the sole casting mold is sealed airtight to the environment. Thus, the method may represent a substantial improvement. In particular, thus, a reduced apparatus-like, complex structure may be implemented, whereby costs may be saved. The walls of the apparatus may be implemented easily and with small wall thicknesses. Furthermore, a maintenance effort may be reduced. In addition, in some embodiments, a possible hazard for the personnel and the environment during operation of the apparatus used for the method decreases, since in particular no, possibly unexpected, outflows of the interior under high pressure may occur. In other methods of the prior art, such an airtight seal is required, such as e.g., in methods in which material is injected into a mold with high pressure.

The method steps may further comprise an absolute value of pressure difference between the sole casting mold and the environment of a maximum of 10% of the environmental pressure. In some embodiments, the absolute value of pressure difference may be a maximum of 8%, or a maximum of 6%, or a maximum of 4%, or a maximum of 2%.

The pressure difference between the sole casting mold and the environment may thus be very low. A low pressure difference may be particularly beneficial, since in particular (but not exclusively) during the injection process, no measures for maintaining the pressure in the sole casting mold are required. The pressure difference may also converge to zero or be zero in some method steps, e.g., if the lasted upper and/or the lower punch of the sole casting mold do not close them. This pressure difference may relate, among other things, to the step of injecting the foamed sole material into the sole casting mold. In the step of bringing the lasted upper into contact with the injected sole material, the pressure difference may in some cases also be higher.

The method may further comprise a geometry change of the sole casting mold to bring the injected sole material into a predefined shape.

The geometry change of the sole casting mold may be enabled by components which are in communication with the sole casting mold. Thus, in a simplified manner, the injected sole material may be molded. For example, a component, e.g., a punch or die, may be provided from a bottom side. A top side of the punch may represent a part of the sole casting mold in which the sole material is present. The predefined shape may be determined by the remaining walls of the sole casting mold in a flexible manner and according to the desired shape of the final product.

The method may further comprise a step of moving the lasted upper towards the sole casting mold.

This may enable a closure of the sole casting mold in a beneficial and efficient manner. The closure may thereby be understood such that by moving the lasted upper towards the sole casting mold, an arrangement may be achieved in which the injected sole material, e.g., foamed material, may substantially not escape at the edges of the upper. The edges may thereby represent the transition between the upper and the sole casting mold. The closure may be an upper closure, for example, if the sole casting mold is opened upwards. An upper closure may be understood as the closing of the upwardly opened sole casting mold and thus the top side of the final sole. Due to the use of the lasted upper as a closing unit, a direct connection between the sole and the lasted upper may be provided in particular in an improved manner. In addition, no further components are required which represent a closure of the top side or possibly another side of the sole casting mold and which are not part of the final product. Thus, the method may be particularly resource-saving. The method may be additionally particularly flexible. This becomes clear in particular in that not only the lasted upper may be moved towards the sole casting mold. Rather, other elements may also be moved towards the sole casting mold, for example, if only individual elements of a shoe, such as e.g., only a sole or the like, are manufactured by the method. Then a different component, such as e.g., a displacer, may be used which may be configured to hold the material in a mold, in some embodiments from the top side, if a component brings the material from the bottom side into a predefined shape. In this case, the displacer may act on the top side as a latching for the material. It is not excluded that the lasted upper moves relative to the sole casting mold after the injection process. In some embodiments, the lasted upper or the displacer moves further towards the sole casting mold after the injection process in order to bring the sole material into a predefined shape. In some embodiments, the previously described punch may also or exclusively be used for this, which presses the material e.g., from bottom to top and possibly compacts it. In some embodiments, both the punch and the lasted upper move, or move towards the sole casting mold. This may in particular also occur after the injection process. In this way, beneficially two possibilities for adapting the shape and/or the pressure application of the injected sole material are provided. In some embodiments, the traverse element, or the punch, bottom punch, or the like, may be configured such that it is moved substantially immediately after injection into an end position. In this way, it may beneficially be ensured that the viscosity of the injected sole material is in an optimal range for shaping. In particular, a longer temporal offset between injection and movement of the traverse element is avoided. Thus, cooling of the sole material may be largely prevented or reduced. In various embodiments, the sole material may thus be processed in the sole casting mold in the warmest state, or in a very warm state, or in the state of a very high temperature and with low viscosity. Thus, the flow properties may be improved, and the sole material may better adapt to the specified geometry of the sole casting mold, in particular to smaller recesses, niches, or strong three-dimensional changes of the shape. Thereby, the entire method may become faster, more efficient and more cost-effective.

The method may further comprise a step of molding a lower surface of the lasted upper such that the lower surface substantially forms an upper closing surface of the sole casting mold.

By providing a closing surface, a heat loss may be reduced. Thus, beneficial material properties, such as the flow property of the injected sole material, may be maintained. The method may become more cost-effective in this manner, since no apparatuses for heating the sole material are required. However, the upper closing surface of the sole casting mold may also be enabled by a displacer.

The method may further be configured such that molding of the lower surface is performed prior to injecting the sole material, wherein the surface continues to exist in the further method steps.

Beneficially, the lasted upper may move towards the sole casting mold prior to injection. Thus, already during the injection process, a shielding against heat loss may be provided. Preserving this shielding for the following method steps may be beneficial, at least to the effect that the heat loss is further prevented.

The injected sole material comprised by the method may further be configured such that it forms a sole.

The method may also enable the provision of only a part of a shoe, e.g., a sole. For this, for example, no lasted upper is required to form a closing surface; instead this may be done by a displacer.

The method may further be configured such that the sole is attached to the lasted upper, wherein the attachment may occur without additional adhesive.

The sole may in some embodiments be attached to the lasted upper without additional adhesive. Thereby, the method may become more efficient, faster, and more productive. In addition, the use of further resources may be saved. However, the sole may also be attached to the upper with the help of additional mechanisms. This could be of benefit for some embodiments. In embodiments, in which only a sole is provided as a final product, no attachment has to occur. In this case, instead of an upper, a displacer may be used, for example, which may be brought into contact with the sole material.

The lasted upper may further comprise the same material as the injected sole material.

The method offers the particular benefit of directly manufacturing a shoe in the so-called direct soling method. In particular, a TPU foam cup sole (e.g., a one-piece midsole and outsole) in combination with a TPU upper may be used. Due to the combination of materials used in this manner, the method for manufacturing a shoe overall may be very economical and particularly efficient. Due to the use of the same material, the upper may be first manufactured from TPU, e.g. knitted, warp-knitted, sewn, crocheted, woven or in any other way, then the upper may be pulled onto a last and this lasted upper may be brought into contact with the sole material and connected in order to manufacture a shoe therefrom. Due to the use of the same material of the upper and the sole, both shoe parts have the same chemical properties, whereby, for example, a recycling of the shoe is improved and simplified. The circulation of the used material over the entire product life cycle of the shoe as well as beyond this may thus be improved in a resource- and environmentally-friendly manner. The distribution of environmentally sustainable products may be substantially improved in this manner. However, in some embodiments, other materials are used for the provision of the upper, for example leather, synthetic leather, or other, usually used materials.

In the following, an apparatus is described, with which the above-described method may be carried out. The technical characteristics shown or described for the method, the benefit of the method, and the improvements over the prior art apply equally to the now following apparatus for carrying out the method.

Some embodiments further relate to an apparatus for manufacturing a shoe, comprising: a) at least one open sole casting mold configured to receive a lasted upper; b) at least one sprayer configured to be placed in communication with the sole casting mold to enable injection of sole material into the sole casting mold; and c) at least one foaming unit configured to foam the sole material prior to injection into the sole casting mold.

In addition, the sole casting mold may beneficially be designed such that it enables direct cooling, for example, in order to allow injected material to be heat-treated or cured in a targeted manner in the sole casting mold. Thus, the curing temperature may be not too high and/or not too low. As a coolant, e.g., water or another suitable liquid may be used. The cooling mechanism may be designed such that cooling channels are introduced into the sole casting mold. The cooling channels may be structure through which the coolant is conducted, and the cooling channels may ensure a better heat transfer and thus a more efficient cooling of the sole material. Thus, the efficiency and the productivity may be increased. This offers a benefit over conventional cooling mechanisms, in which the cooling is carried out via outer elements, e.g., the jaws of a sole casting mold. In such conventional cooling mechanisms, the path length from the injected material to the coolant is substantially larger, whereby the heat transfer resistance is increased and the cooling is thus not efficient. According to some embodiments, the path length from the injected material to the coolant may be beneficially reduced, among other things.

The sole casting mold, which may be comprised by the apparatus, may be in some embodiments substantially not sealed airtight with the received upper. The apparatus may further enable an air entry and/or air exit between the sole casting mold with the received upper and the environment. The absolute value of pressure difference between the sole casting mold with the received upper and the environment of the present apparatus may further be a maximum of 10% of the environmental pressure. In some embodiments, the absolute value of pressure difference may be a maximum of 8%, or a maximum of 6%, or a maximum of 4% and or a maximum of 2%.

This arrangement enables, among other things, a cost-effective provision of the components of the apparatus. In particular, no pressure chamber has to be provided. The wall thicknesses may also turn out to be smaller. A further benefit is that no complex safety measures are required, such as in apparatuses comprising pressure chambers, as is the case with high-pressure methods for manufacturing shoes.

The sole material and/or the sprayer of the present apparatus may be configured such that the direction in which the sole material is injected into the sole casting mold changes relative to the sole casting mold over the time.

The injected sole material of the present apparatus may be configured such that it experiences substantially no further expansion.

The sole material of the present apparatus may further be configured such that it comprises a density change of a maximum of 5% relative to the density of the sole material during the injecting in a time of 0.5 seconds after injecting into the sole casting mold. Thereby, during the injecting, it is to be understood as the time in which the sole material gets into the sole casting mold.

Thus, among other things, the benefit may be achieved that the material already foamed outside the sole casting mold does not expand substantially further immediately after getting into the sole casting mold. In some embodiments, the time may also be 0.3 seconds, or 0.1 seconds. The maximum density change may in some embodiments be 3% or 1%. Thus, it may be beneficially ensured that the spatial expansion of the sole material foamed outside the sole casting mold is already largely determined. By a reduced expansion of the foamed sole material within the sole casting mold, a foaming over of edges of the sole casting mold may also be reduced. In addition, in this way, the determination of the travel paths of a lasted upper and a movable component of the sole casting mold in order to bring the sole material into contact with the upper may be adjusted in advance and thus maintained for the entire shoe production and may be not subject to interfering influences or possibly fluctuations due to material contaminations, which would lead to a different expansion behavior.

The foaming unit comprised by the apparatus may comprise at least: a.) a mixer configured to mix a first material comprising at least one of the list of thermoplastics, elastomers, and thermosets and at least one blowing agent into a mixture; b) a dryer configured to dry the mixture or the first material; and c.) a compactor and a heater configured to compact the mixture and to supply heat to the mixture to cause a foaming of the mixture.

Providing of the at least one blowing agent may in some embodiments occur in the form of pellets.

The dryer comprised by the apparatus may comprise a heating unit and a fan unit configured to provide a maximum moisture content of the mixture of 1.0%. In some embodiments, the maximum moisture content of the mixture may also be 1.5%, or 1%, or 0.4%, or below 0.4%.

The compactor comprised by the apparatus and the heater comprised by the apparatus may comprise at least one extruder and at least one heating system, wherein the extruder may comprise at least one screw which may be configured such that the mixture may be blended, compacted, and transported by rotational movement of the screw.

The sole casting mold comprised by the apparatus may further comprise a traverse element configured to change the geometry of the sole casting mold and to bring the injected sole material into a predefined shape, wherein a movement of the traverse element in one direction decreases the volume of the sole casting mold, and wherein a movement of the traverse element in the opposite direction increases the volume of the sole casting mold.

This arrangement may enable the targeted control of pressure application of the traverse element to the injected sole material. For example, the traverse element may be arranged at a bottom side of the sole casting mold, and it may also be part of the sole casting mold. The traverse element may further move relative to the sole casting mold. In an beneficial manner, one or several channel opening(s) may also be closed by the movement of the traverse element in order to thus prevent a material backflow from the sole casting mold into the opening. The traverse element, or the punch, may be driven with 20-120 kN, or with 40-100 kN, or with 60-80 kN, or also with 70 kN, for example.

The traverse element comprised by the present apparatus may be movable in a first translational direction, wherein the first translational direction is substantially perpendicular to a lower surface of the lasted upper.

This arrangement enables a simple movement mechanism of the traverse element, whereby the complexity and the technical effort of the apparatus may be reduced.

The sole casting mold comprised by the apparatus may comprise at least two opposing elements configured to receive and release the upper, wherein the at least two opposing elements are movable in a second translational direction, wherein the receiving and releasing of the upper may occur by an opposing translational movement of the at least two elements. The first translational direction and the second translational direction described with respect to the apparatus may be oriented substantially perpendicular to each other.

The at least two opposing elements may represent lateral supports and may also serve to describe the circumferential shape, for example, the lateral shape of a sole. After, for example, the lasted upper is lowered, the apparatus may provide a support for the toe region of the upper in order to prevent a movement of the upper in the further course of the method, in particular during injection. If only a shoe part, such as e.g., a sole, is manufactured, such a support may be omitted. Then, the injection of the material may occur, which may be followed by the movement of the traverse element in the first translational direction, for example, from bottom to top in the direction of the lasted upper. The traverse element is configured such that it may bring the sole material into connection with the upper by the upward movement.

The sole casting mold comprised by the apparatus and/or the traverse element may further comprise plastic material. The plastic material may comprise polymer materials such as e.g., thermoplastics and/or thermosets.

This arrangement may enable the provision of a very simplified apparatus, whereby costs in the manufacturing of the apparatus may be saved. The apparatus may thereby be manufactured in a very simplified manner. In particular, different sole casting molds may be quickly manufactured from polymer materials. Thus, different sole molds may be flexibly produced. The sole casting molds may even be manufactured in a cost-effective manner by a 3D printing method.

The sole material comprised by the apparatus may be injected into the sole casting mold by a channel comprised by walls of the sole casting mold, wherein the size of the opening of the channel may be adjustable, and wherein the diameter of the opening is in the range of 2-30 mm. The size of the opening of the channel comprised by the present apparatus may also be in the range of 3-15 mm or also in the range of 6-12 mm. In some embodiments, the diameter of the channel may substantially correspond to the diameter of the sprayer.

The adjustability and adaptability of the opening of the channel may beneficially provide the use of a plurality of possible materials. In particular, in this way, a plurality of materials may also be enabled, which may have different viscosities. At a higher viscosity, larger openings may be offered, whereby the surface to volume ratio may be reduced and thus the frictional resistance of the material may be decreased. However, smaller openings for viscous materials may also be comprised by some embodiments. For the channel, in particular different aperture/throttle geometries may also be used, for example, circular/angular/oval or other geometries, which are all comprised by some embodiments. The diameter may be designed circular with a diameter of, for example, 7 mm. In other embodiments of the sprue channels, diameters of 5 mm may be used. A reduced diameter may cause an increased flow rate of the material. Thus, it may be beneficially ensured that, despite the increased surface to volume ratio, fewer material accumulations will occur at the sprue channel, since a formation of this accumulation more often—due to the increased speed—detaches from the sprue channel and thus gets into the mold in smaller amounts. A possible insulating effect of the material accumulations within the mold may thus be reduced. A possible local overheating due to material accumulations in the mold, which may possibly be caused by shear forces, may thus be avoided. A merit of some embodiments is to cause lower material accumulations at smaller diameter sizes and thus to beneficially reduce discolorations in the final product, which are caused by material accumulations dissolved and transported into the mold. Depending on the material mixture, the sprue channel may beneficially be designed as a conical sprue channel with, for example, a diameter of 7 mm at the inlet (nozzle side) and a diameter of 5 mm at the outlet (cavity). Further, the sprue channel may be replaced in a simplified manner and thus provide, for example, a sprue channel with a diameter of, for example, 7 mm, which has a throttle with a diameter of 5 mm. The cross-sections may be arbitrarily adaptable to the inlets/outlets and the intermediate areas.

The present apparatus may further comprise a plurality of sole casting molds, wherein the sole casting molds may be arranged movable to the at least one sprayer, wherein the apparatus may be configured such that the method for manufacturing a shoe may be applied continuously using the sole casting molds.

In this way, shoes may be produced faster. In particular, the use of only one sprayer may be utilized in order to operate several sole casting molds. This reduces the costs of the apparatus and the method. However, several sprayers may also be used. This may happen if the plurality of sole casting molds exceeds a number at which the use of only one sprayer would be uneconomical.

The sole casting molds comprised by the apparatus may further be arranged circularly and configured such that a relative movement to the at least one sprayer may be performed by rotation about the central axis of the circular arrangement.

In this way, the production of several shoes may be enabled in a space-saving manner. The circular arrangement may, for example, be a rotating table. The sprayer or the nozzle unit for injecting the material can be moved translationally in one direction towards the respective sole casting mold in use, inject the sole material, and finally be moved backwards away. Then, the rotating table may be rotated further about an angular range so that the subsequent sole casting mold may be used. It may be particularly beneficial that the foaming unit and thus the mechanisms comprised therein for mixing, drying, compacting, and heating can be provided simply. Thereby, the entire method becomes even more efficient.

Some embodiments further comprise a shoe which may be manufactured according to the method for manufacturing a shoe.

In various embodiments, the shoe comprises the particular benefits provided by the method and the apparatus. Among other things, the shoe may comprise a very light sole since the sole material is already foamed before injection. Moreover, the shoe may be particularly attractive and aesthetically designed, since no adhesive or a connecting element for mechanically connecting both parts is required for connecting the sole to the upper. In particular, residues caused by an adhesive can thus be prevented. Such residues may often manifest themselves visibly on the outer surfaces of the shoe, from which the product quality and appearance suffer such that the attractiveness for the customer is reduced. Moreover, the adhesive and the shoe material often contain different chemical properties, whereby the aging process of the involved materials has different characteristics and both shoe elements may, for example, detach from each other, whereas the individual elements still have very good properties, e.g., mechanical properties. All these disadvantages may be overcome by the shoe provided here.

In particular, some embodiments may, among other things, enable the provision of plasticized—and at the same time—foamed TPU material without high pressure and thus the manufacture of a shoe or a shoe sole without adhesive in one manufacturing step. The shoes manufactured by this method and this apparatus may be particularly firmly connected to each other between the shoe sole and the upper. In particular, they may be difficult to mechanically detach from each other and thus offer a high durability, whereby the shoes become particularly durable and thus the sustainability is promoted. The recycling of the shoe may be particularly improved by the connection of the shoe sole and the upper without the use of adhesive, since, among other things, no separation from the chemicals used for the adhesive has to occur. Thus, a further contribution to environmental protection is made.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

In the following, only some embodiments are described in detail. However, the present invention is by no means limited to these, but comprises a plurality of further embodiments without departing from the scope of the invention as encompassed. In particular, the following embodiments may be modified or changed in a variety of ways and in particular combined with each other. Further, the features disclosed in the shown embodiments are also to be considered separately and detached from each other and may also be omitted in some embodiments or transferred to other embodiments.

While the following embodiments are primarily described with reference to a shoe, the person skilled in the art will appreciate that the method and the apparatus may be applied equally by the injection of the foamed material during the manufacture of any desired footwear or article.

In the present figures and the description, the same reference numerals refer to the same elements. The figures may not be true to scale and the relative size, proportions and depiction of the elements in the figures may be exaggerated for clarity, presentation and simplicity. The use of the term “sole material” may also be understood as “foamed sole material”.

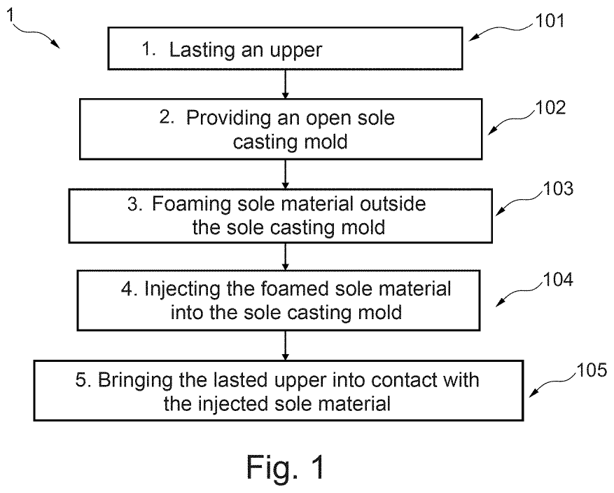

FIG. 1 shows a flow chart according to various embodiments of the method (1). In a first step, an upper (10) is lasted (101), thereafter a sole casting mold (15) is provided (102). Further, foaming (103) of sole material (20) occurs outside the sole casting mold (15). Subsequently, the foamed sole material (20) is injected (104) into the sole casting mold (15). Finally, the lasted upper (10) is brought into contact with the injected sole material (20) (105). After injecting, the sole material may experience a density change of a maximum of 5% relative to the density of the sole material immediately before injecting.

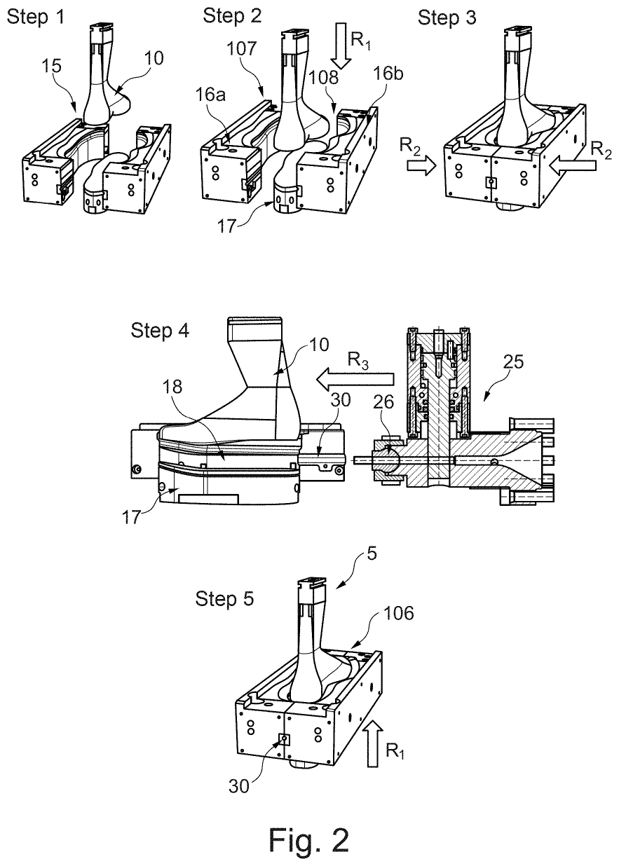

FIG. 2 shows an illustrated flow diagram according to various embodiments of the method (1) together with the apparatus (5) for manufacturing a shoe. For reasons of clarity, the reference numerals are partially limited to certain steps of the flow diagram. In step 1, the lasted upper (10) as well as the sole casting mold (15) is shown. In addition, two opposing elements for receiving and releasing the upper (16a, 16b) are shown which represent components of the sole casting mold (15) and which may be translationally moved in the lateral direction R2 (see step 3). Further, the traverse element (17) of the sole casting mold is shown which may also be referred to as punch or bottom punch and is translationally movably arranged in the direction R1. In step 2, the lasted upper (10) is translationally moved (107) towards the sole casting mold along the direction R1. In addition, it is thus ensured that a lower surface is molded (108) which substantially represents an upper closing surface of the sole casting mold (15). In particular, the lower surface is molded by the lasted upper (10). If a displacer is used instead of an upper (10), e.g., in order to manufacture only a shoe sole, the statements made here with respect to the lasted upper (10) may be applied equally to the displacer. In step 3, the two lateral, opposing elements (16a, 16b) are translationally moved in the direction R2. In this way, the sole casting mold (15) is nearly closed, however, the sole casting mold is at least not sealed airtight. No seals are provided at the edges of the sole casting mold (15) in order to explicitly prevent an air exchange between the thereby formed cavity (18), which is formed by the interior of the sole casting mold (15), and the environment. Therefore, a sole casting mold (15) is also referred to as “open” within the scope of the present disclosure.

Step 4 shows the cavity (18) in a lateral view. In addition, it is indicated in step 4 that the sprayer (25) together with the spraying needle (26) is translationally moved in the direction R3 towards the sole casting mold (15). Thereby, the sprayer (25) is attached to the channel (30) comprised by the sole casting mold in a form-fit manner. Between step 4 and step 5, the injection (104) of the foamed sole material (20) occurs through the sprayer (25), the spraying needle (26) and the channel (30) into the cavity (18). Subsequently, in a step not shown in FIG. 2, the sprayer (25) are translationally moved backwards away from the sole casting mold (15) in the reversed direction of the direction R3 indicated in step 4. Finally, in step 5, the movement of the traverse element (17) occurs in the direction R1, e.g., upwards towards the lasted upper (10). This is accompanied by a geometry change (106) of the sole casting mold (15). In this case, the injected sole material (20) is compacted and brought into a predefined shape by the nature of the sole casting mold (15). Moreover, the movement and thus the geometry change (106) of the sole casting mold (15) of the traverse element (17) occurs so far in the direction R1 that the channel is closed. Thus, a backflow of the sole material (20) is prevented.

As shown in FIG. 2, the step of molding a lower surface (108) of the lasted upper (possibly the displacer) may occur before the step of injecting (104) the foamed sole material (20). The injected sole material (20) forms the shape of a sole in this method. Moreover, the sole material (20) may contain the same material as the upper (10) or be the same material and an entire shoe may be provided directly by the connection of the sole to the upper (10).

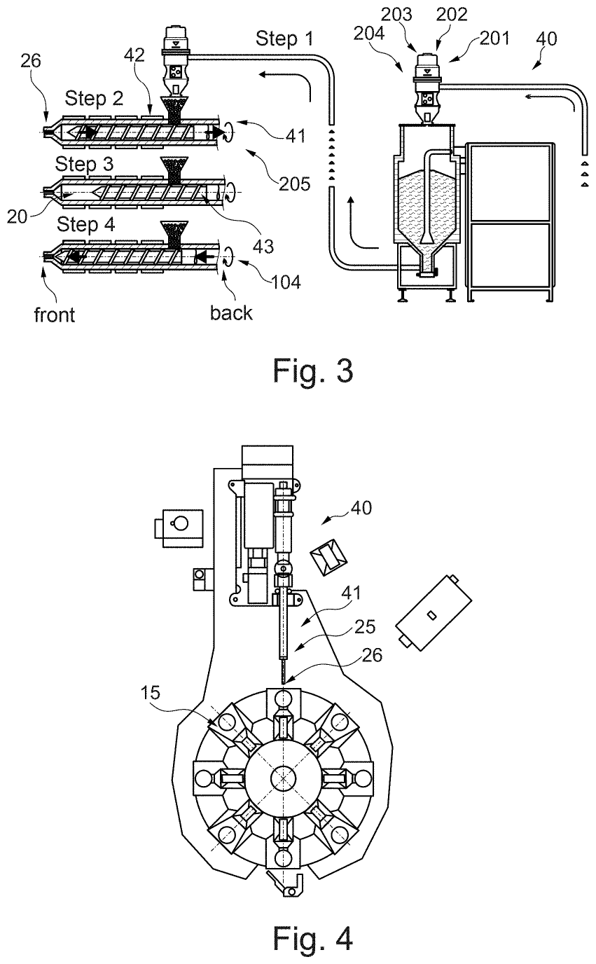

FIG. 3 shows a diagram for preparing the sole material (20) outside the sole casting mold (15) in a foaming unit (40) according to various embodiments. The foaming unit (40) may also be referred to as injection and plasticising unit (SPE). In step 1, the material provision (201) of a first material and the provision (202) of a blowing agent occur. Finally, a mixture is formed (203) of the first material, in some embodiments TPU pellets, and the blowing agent. The first material may be a thermoplastic, elastomer, or a thermoset, in some embodiments the first material is a thermoplastic. The blowing agent may be a solid blowing agent and/or a gaseous blowing agent, wherein solid blowing agents may be chemical and/or physical solid blowing agents or a combination thereof, such as, e.g., Konz V 2893 and/or Konz V 2894, wherein gaseous blowing agents may be, e.g., a CO2 gas injection. By choosing the materials and the quantitative composition, the properties such as density, heat resistance, and viscosity of the sole material (20) may be defined. Different TPU pellets may also be mixed with the blowing agent. Due to the mixing, a homogeneous distribution may be provided, whereby the foaming may be improved. In an intermediate step (204), the TPU pellets may be dried to reduce the moisture. This drying (204) may be applied to the mixture as well as only to the TPU pellets. In the latter case, the drying (204) would thus take place without the blowing agent.

In steps 2 to 4, one extruder (41) each is shown. For reasons of clarity, the reference numerals are not shown in all steps. In step 2, the mixture of the materials (e.g., the dried TPU pellets and the blowing agents) are fed to a screw (43) of an extruder (41). The screw (43) rotates and thereby draws in the mixture from a material feeding unit (a feeder). The mixture is driven in particular forward by the rotational movement of the screw (43). The screw (43) moves backwards, indicated by the arrows in step 2 of FIG. 3.

In step 2 and step 3, a compacting and heating (205) of the mixture occurs with the help of a heating unit (42) and the compaction by the screw (43), in particular in the intermediate spaces of the screw (43), to cause an interaction of the mixture. This thus represents the plastification or the melting of the TPU pellets. In addition, the reaction occurs with the blowing agent so that the entire sole material (20) foams, wherein the foaming is accompanied by a decrease in density. In step 3, the injection (104) of the foamed sole material (20) occurs, wherein the entire screw (43) is moved forward, this is indicated by the arrows in step 4 of FIG. 3. The direction forward in the direction of the spraying needle is opposite to the direction backwards from step 2. The density of the injected sole material may here be between 0.2-1.2 g/cm³.

FIG. 4 shows an apparatus of a plurality of sole casting molds (15) with a sprayer (25) and a foaming unit (40) according to various embodiments. In the depiction, eight sole casting molds (15) are shown. Each sole casting mold (15) consists of at least the two opposing elements (16a, 16b) for receiving and releasing the upper, the traverse element (17) as well as the channel (30), whereby the sole material may be introduced (not provided with reference numerals in FIG. 4), as well as the further above-described structural elements. The foaming unit (40) in this example is only present in a simple manner and contains at least the extruder (41), the sprayer (25) and the spraying needle (26) as well as the further above-described structural elements. The sole casting molds (15) are present in a circular arrangement, which may rotate about the center point. By the rotational movement about an angle of 360°/8=45°, the next sole casting mold (15) each may be moved into the correct position in order to apply the above-described method to the sole casting mold (15) now in operation.

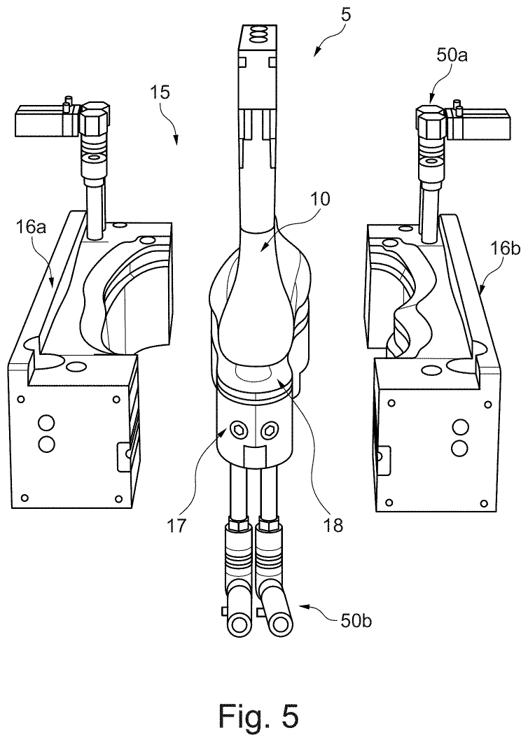

FIG. 5 shows an example of the apparatus (5) for manufacturing a shoe with cooling channels (50a, 50b). The cooling channels (50a, 50b) as well as the connection points in order to allow cooling liquid, e.g., water, to flow in and out, are provided in the traverse element (17) as well as in the two opposing elements (16a, 16b) for receiving and releasing the upper (10). The cooling channels introduced directly into the sole casting mold (15) in this manner may ensure a more efficient cooling, since the heat transfer is increased. In particular, the heat transfer coefficient may be increased, since the distance between the warm medium, the sole material (20) and the cooling medium is reduced. In addition, a curved course of the cooling channels within the sole casting mold (15), due to matching of the channels to the sole casting mold (15), may ensure a better mixing of the coolant itself and possibly a turbulent boundary layer, so that overall the heat transfer coefficient may be further increased. The step of cooling occurs after the injection. The two opposing elements (16a, 16b) for receiving and releasing the upper (10), which are shown in FIG. 5, abut each other, e.g., as shown in step 5 in FIG. 2, and may be not remote from each other as shown in FIG. 5. During cooling, the cavity (18) still remains closed, in particular, the lasted upper (10) continues to close the top side for the most part, so that, however, air may still escape. The temperature of the sole material (20) may be between 80° C. and 260° C. The cooling may be adjusted such that the sole casting mold (15) has a temperature between 15° C. and 50° C., which corresponds to the final temperature of the sole material (20) after demolding.

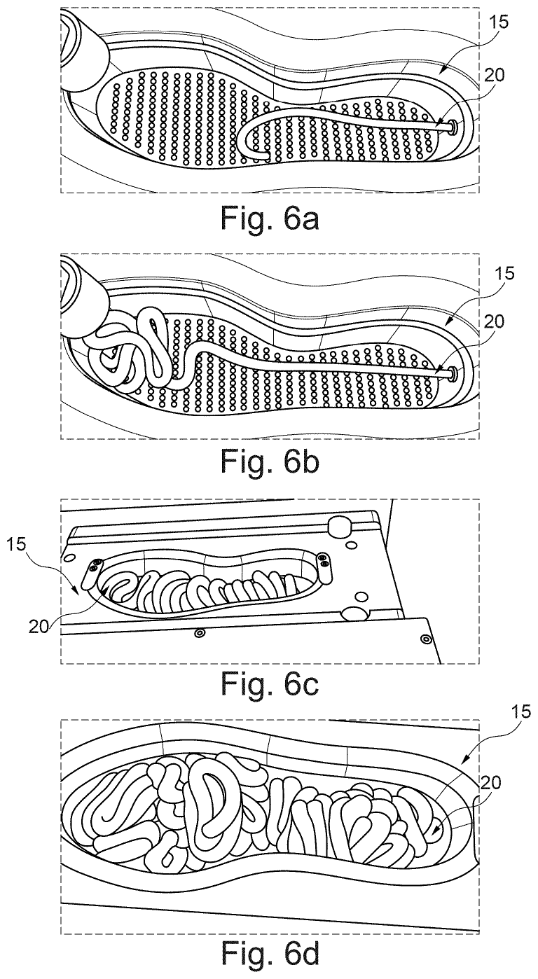

FIG. 6a to FIG. 6d show an example of the method (1) and the apparatus (5) for manufacturing a shoe during an injection process at different times. Therein, the time progresses from FIGS. 6a toward FIG. 6d. The injection of the sole material (20) into the sole casting mold (15) is shown. For reasons of clarity, no lasted upper (10) is shown for covering the top side of the open sole casting mold (15). The foamed sole material (20) forms a curved course during injection, which resembles a serpentine shape. The foamed sole material (20) distributes very well and very quickly within the sole casting mold (15). In addition, the foamed sole material (20) does not inject out of the sole casting mold (15), but remains within the cavity (18). It can already be seen from this that no sealing has to occur as in high-pressure methods, but air may escape from the cavity (18), for example, via gaps between the bottom side of the lasted upper (10). This is in particular the case when the traverse element (17) travels upwards towards the lasted upper (10). Thus, the direction in which the sole material (20) is injected into the sole casting mold (15) changes relative to the sole casting mold (15), over time.

### LIST OF REFERENCE NUMERALS

1: Method for manufacturing a shoe
5: Apparatus for manufacturing a shoe
10: (lasted) upper
15: Sole casting mold
16a: The first of the two opposing elements for receiving and releasing the upper
16b: The second of the two opposing elements for receiving and releasing the upper
17: Traverse element of the sole casting mold
18: Cavity
20: (foamed) sole material
25: Sprayer
26: Spraying needle
30: Channel in the sole casting mold
40: Foaming unit
41: Extruder
42: Heater/Heating unit
43: Screw
50a: Cooling channel
50b: Further cooling channel
101: Lasting an upper
102: Providing an open sole casting mold
103: Foaming of sole material outside the sole casting mold
104: Injecting the foamed sole material into the sole casting mold
105: Bringing the lasted upper into contact with the injected sole material
106: Geometry change of the sole casting mold
107: Moving the lasted upper towards the sole casting mold
108: Molding a lower surface
201: Providing a first material
202: Providing at least one blowing agent
203: Forming a mixture of the first material and the blowing agent
204: Drying the mixture or the first material
205: Compacting and heating the mixture

In the following, further examples are described to facilitate the understanding of the invention:

Example 1. A method (1) for manufacturing a shoe, comprising the steps:

a) lasting an upper (101);
b) providing an open sole casting mold (102);
c) foaming sole material outside the sole casting mold (103);
d) injecting the foamed sole material into the sole casting mold (104); and
e) bringing the lasted upper into contact with the injected sole material (105).

Example 2. The method of Example 1, wherein the sole material experiences a density change of at most 5% relative to the density of the sole material during the injecting in a time of 0.5 seconds after injecting into the sole casting mold.

Example 3. The method of any one of the preceding Examples, wherein foaming (103) of the sole material comprises:

c.1) providing a first material (201), the first material comprising at least one of the list of thermoplastics, elastomers, and thermosets; and
c.2) providing at least one blowing agent (202).

Example 4. The method of the preceding Example, wherein providing of the first material (201) occurs in the form of pellets, and wherein providing of the at least one blowing agent (202) preferably occurs in the form of pellets.

Example 5. The method of any one of the preceding Examples 3-4, wherein foaming (103) of the sole material further comprises:

c.3) forming a mixture of the first material and the blowing agent (203); and
c.4) drying the mixture (204), wherein drying is arranged such that the maximum moisture content of the mixture is 2.0%.

Example 6. The method of the preceding Example, wherein foaming (103) of the sole material further comprises:

c.5) compacting and heating the mixture (205) to cause an interaction, in particular a foaming, of the mixture, wherein the foaming is accompanied by a decrease in density.

Example 7. The method of any one of the preceding Examples, wherein the density of the injected sole material is in a range between 0.2-1.2 g/cm³

Example 8. The method of any one of the preceding Examples, wherein the direction in which the sole material is injected into the sole casting mold changes relative to the sole casting mold over the time.

Example 9. The method of any one of the preceding Examples, wherein the method steps comprise an air entry and/or air exit between the sole casting mold and the environment.

Example 10. The method of any one of the preceding Examples, wherein the method steps comprise an absolute value of pressure difference between the sole casting mold and the environment of a maximum of 10% of the environmental pressure.

Example 11. The method of any one of the preceding Examples, wherein the method further comprises a geometry change (106) of the sole casting mold to bring the injected sole material into a predefined shape.

Example 12. The method of any one of the preceding Examples, further comprising the step of moving the lasted upper towards the sole casting mold (107).

Example 13. The method of any one of the preceding Examples, further comprising the step of molding a lower surface (108) of the lasted upper such that the lower surface substantially forms an upper closing surface of the sole casting mold.

Example 14. The method of the preceding Example, wherein molding of the lower surface (108) is performed prior to injecting (104) the sole material, wherein the surface continues to exist in the further method steps.

Example 15. The method of any one of the preceding Examples, wherein the injected sole material is configured to form a sole.

Example 16. The method of the preceding Example, wherein the sole is attached to the lasted upper, wherein the attachment occurs without additional adhesive.

Example 17. The method of any one of the preceding Examples, wherein the lasted upper comprises the same material as the injected sole material.

Example 18. An apparatus (5) for manufacturing a shoe, comprising:

a) at least one open sole casting mold (15) configured to receive a lasted upper (10);
b) at least one spraying means (25) configured to be placed in communication with the sole casting mold (15) to enable injection of sole material (20) into the sole casting mold (15); and
c) at least one foaming unit (40) configured to foam the sole material (20) prior to injection into the sole casting mold (15).

Example 19. The apparatus of the preceding Example, wherein the sole casting mold with the received upper is substantially not sealed airtight.

Example 20. The apparatus of any one of the preceding Examples 18-19, wherein an air entry and/or air exit between the sole casting mold with the received upper and the environment is enabled.

Example 21. The apparatus of any one of the preceding Examples 18-20, wherein an absolute value of pressure difference between the sole casting mold with the received upper and the environment of a maximum of 10% of the environmental pressure is comprised.

Example 22. The apparatus of any one of the preceding Examples 18-21, wherein the sole material and/or the spraying means are configured such that the direction in which the sole material is injected into the sole casting mold changes relative to the sole casting mold over the time.

Example 23. The apparatus of any one of the preceding Examples 18-22, wherein the injected sole material is configured to experience substantially no further expansion.

Example 24. The apparatus of any one of the preceding Examples 18-23, wherein the sole material is configured to comprise a density change of a maximum of 5% relative to the density of the sole material during the injecting in a time of 0.5 seconds after injecting into the sole casting mold.

Example 25. The apparatus of any one of the preceding Examples 18-24, wherein the foaming unit comprises at least:

a) means for mixing configured to mix a first material comprising at least one of the list of thermoplastics, elastomers, and thermosets and at least one blowing agent into a mixture;
b) means for drying configured to dry the mixture or the first material; and
c) means for compacting and means for heating configured to compact the mixture and to supply heat to the mixture to cause a foaming of the mixture.

Example 26. The apparatus of the preceding Example, wherein the means for drying comprises a heating unit and a fan unit configured to provide a maximum moisture content of the mixture of 2.0%.

Example 27. The apparatus of any one of the preceding Examples 25-26, wherein the means for compacting and the means for heating comprises at least one extruder and at least one heating system, wherein the extruder comprises at least one screw configured such that the mixture can be blended, compacted and transported by rotational movement of the screw.

Example 28. The apparatus of any one of the preceding Examples 18-27, wherein the

sole casting mold further comprises a traverse element configured to change the geometry of the sole casting mold and to bring the injected sole material into a predefined shape, wherein a movement of the traverse element in one direction decreases the volume of the sole casting mold, and wherein
a movement of the traverse element in the opposite direction increases the volume of the sole casting mold.

Example 29. The apparatus of the preceding Example, wherein the traverse element is movable in a first translational direction, wherein

the first translational direction is substantially perpendicular to a lower surface of the lasted upper.

Example 30. The apparatus of any one of Examples 18-29, wherein the sole casting mold comprises at least two opposing elements configured to receive and release the upper, wherein

the at least two opposing elements are movable in a second translational direction, wherein receiving and releasing of the upper occurs by an opposing translational movement of the at least two elements.

Example 31. The apparatus of the preceding Example in combination with Example 29, wherein the first translational direction and the second translational direction are oriented substantially perpendicular to each other.

Example 32. The apparatus of any one of Examples 28-31, wherein the sole casting mold and/or the traverse element comprises plastic material.

Example 33. The apparatus of any one of Examples 18-32, wherein the sole material is injected into the sole casting mold by means of a channel comprised by walls of the sole casting mold, wherein the size of the opening of the channel is adjustable, and wherein the diameter of the opening is in the range of 2-16 mm.

Example 34. The apparatus of the preceding Example, wherein the size of the opening of the channel is in the range of 2-30 mm or wherein the diameter of the channel substantially corresponds to the diameter of the spraying means.

Example 35. The apparatus of any one of Examples 18-34, comprising a plurality of sole casting molds, wherein the sole casting molds are arranged movable to the at least one spraying means, wherein the apparatus is configured such that the method of any one of Examples 1-17 can be applied continuously using the sole casting molds.

Example 36. The apparatus of the preceding Example, wherein the sole casting molds are arranged circularly, and are configured such that a relative movement to the at least one spraying means can be performed by rotation about the central axis of the circular arrangement.

Example 37. A shoe manufactured according to a method of any one of Examples 1-17.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. A method for manufacturing a shoe, comprising:
a) lasting an upper;
b) providing an open sole casting mold;
c) foaming sole material outside the sole casting mold;
d) injecting the foamed sole material into the sole casting mold; and
e) bringing the lasted upper into contact with the injected sole material.

2. The method of claim 1, wherein the sole material experiences a density change of at most 5% relative to the density of the sole material during the injecting in a time of 0.5 seconds after injecting into the sole casting mold.

3. The method of claim 1, wherein the foaming of the sole material comprises:
c.1) providing a first material, the first material comprising at least one selected from thermoplastics, elastomers, or thermosets; and
c.2) providing at least one blowing agent.

4. The method of claim 3, wherein providing of the first material occurs in the form of pellets, and wherein providing of the at least one blowing agent occurs in the form of pellets.

5. The method of claim 3, wherein the foaming of the sole material further comprises:
c.3) forming a mixture of the first material and the blowing agent; and
c.4) drying the mixture, wherein drying is arranged such that the maximum moisture content of the mixture is 2.0% or less.

6. The method of claim 5, wherein the foaming of the sole material further comprises:
c.5) compacting and heating the mixture to cause an interaction that includes a foaming of the mixture, wherein the foaming is accompanied by a decrease in density.

7. The method of claim 1, wherein the density of the injected sole material is in a range between 0.2-1.2 g/cm³

8. The method of claim 1, wherein the direction in which the sole material is injected into the sole casting mold changes relative to the sole casting mold over time.

9. The method of claim 1, wherein the method steps comprise an air entry and/or air exit between the sole casting mold and the environment.

10. The method of claim 1, wherein the method steps comprise an absolute value of pressure difference between the sole casting mold and the environment of a maximum of 10% of the environmental pressure.

11. The method of claim 1, wherein the method further comprises changing a geometry of the sole casting mold to bring the injected sole material into a predefined shape.

12. The method of claim 1, further comprising moving the lasted upper towards the sole casting mold.

13. The method of claim 1, further comprising molding a lower surface of the lasted upper such that the lower surface substantially forms an upper closing surface of the sole casting mold.

14. The method of claim 13, wherein molding of the lower surface is performed prior to injecting the sole material, wherein the surface continues to exist in further method steps.

15. The method of claim 1, wherein the injected sole material is configured to form a sole.

16. The method of claim 15, wherein the sole is attached to the lasted upper, wherein the attachment occurs without additional adhesive.

17. The method of claim 1, wherein the lasted upper comprises the same material as the injected sole material.

18. An apparatus for manufacturing a shoe, comprising:
a) at least one open sole casting mold configured to receive a lasted upper;
b) at least one sprayer configured to be placed in communication with the sole casting mold to enable injection of sole material into the sole casting mold; and
c) at least one foaming unit configured to foam the sole material prior to injection into the sole casting mold.

19. The apparatus of claim 18, wherein the sole casting mold with the received upper is substantially not sealed airtight; or
wherein an air entry and/or air exit between the sole casting mold with the received upper and the environment is enabled; or
wherein an absolute value of pressure difference between the sole casting mold with the received upper and the environment of a maximum of 10% of the environmental pressure is comprised; or
wherein the sole material and/or the sprayer are configured such that the direction in which the sole material is injected into the sole casting mold changes relative to the sole casting mold over the time; or
wherein the injected sole material is configured to experience substantially no further expansion; or
wherein the sole material is configured to comprise a density change of a maximum of 5% relative to the density of the sole material during the injecting in a time of 0.5 seconds after injecting into the sole casting mold; or
wherein the foaming unit comprises at least:
a) a mixer configured to mix (i) a first material comprising at least one selected from thermoplastics, elastomers, or thermosets, and (ii) at least one blowing agent into a mixture;
b) a dryer configured to dry the mixture or the first material, wherein the dryer comprises a heating unit and a fan unit configured to provide a maximum moisture content of the mixture of 2.0%; and
c) a compactor and heater configured to compact the mixture and to supply heat to the mixture to cause a foaming of the mixture, wherein the compactor and the heater comprises at least one extruder and at least one heating system, wherein the extruder comprises at least one screw arranged such that rotational movement of the screw causes the mixture to be blended, compacted and transported; or
wherein the sole casting mold further comprises a traverse element configured to change the geometry of the sole casting mold and to bring the injected sole material into a predefined shape, wherein a movement of the traverse element in one direction decreases the volume of the sole casting mold, and wherein a movement of the traverse element in the opposite direction increases the volume of the sole casting mold, wherein the traverse element is movable in a first translational direction, wherein the first translational direction is substantially perpendicular to a lower surface of the lasted upper, wherein the sole casting mold and/or the traverse element comprises plastic material; or
wherein the sole casting mold comprises at least two opposing elements configured to receive and release the upper, wherein the at least two opposing elements are movable in a second translational direction, wherein receiving and releasing of the upper occurs by an opposing translational movement of the at least two elements, wherein the first translational direction and the second translational direction are oriented substantially perpendicular to each other; or
wherein the sole material is injected into the sole casting mold by a channel comprised by walls of the sole casting mold, wherein a size of an opening of the channel is adjustable, and wherein the diameter of the opening is in the range of 2-16 mm or substantially corresponds to the diameter of the sprayer; or
wherein the apparatus further comprises a plurality of sole casting molds, wherein the sole casting molds are arranged movable to the at least one sprayer, wherein the sole casting molds are arranged circularly, and are configured such that a relative movement to the at least one sprayer is performed by rotation about the central axis of the circular arrangement.

20-36. (canceled)

37. A shoe manufactured according to a method of claim 1.
